(19) United States
(12) Patent Application Publication
(10) Pub. No.: US 2011/0301789 A1
(43) Pub. Date: Dec. 8, 2011

(54) BATTERY POWER SERVICE MANAGEMENT SYSTEM AND BATTERY POWER SERVICE MANAGEMENT METHOD

(76) Inventor: Liam-Yung Sung, Taipei (TW)

(21) Appl. No.: 12/793,679

(22) Filed: Jun. 4, 2010

(51) Int. Cl. G06F 7/00; H02J 7/00

(52) U.S. Cl. 701/22; 320/109; 180/65.29

(57) ABSTRACT

A battery power service management system and a battery power service management method are provided. The present invention is adapted for providing an instant battery power service in which a backup battery having an electric power volume sufficient for driving the vehicle to run a desired mileage is provided for replacing an original battery originally used by the vehicle which electric power volume is insufficient for driving the vehicle to run the desired mileage, and/or providing a non-instant battery power service in which the original battery is charged to obtain an electric power volume sufficient for driving the vehicle to run the desired mileage. The battery power service management system and the battery power service management method of the present invention are capable of providing a corresponding battery power service in accordance with the desired mileage that the hybrid vehicle or the electric vehicle is desired to run.

### BACKGROUND OF THE INVENTION

1. Field of the Invention

The present invention relates generally to a battery power service management system and a battery power service management method corresponding thereto, and more particularly to a battery power service management system and a battery power service management method corresponding thereto adapted for providing a battery power service for hybrid vehicles or electric vehicles. The present invention is adapted for providing a corresponding battery power service in accordance with the mileage that the vehicle desired to be driven.

2. The Prior Arts

Currently, the development of the automotive industry is closely correlated to the environmental protection consideration. For the purpose of reducing the exhaust emission and the consumption of gasoline, hybrid vehicles and electric vehicles are provided for the customers as alternatives options. As such, electric power, as a substitutive option, can also be used for driving a car.

Typically, a hybrid vehicle or an electric vehicle includes a rechargeable battery adapted for providing electric power to drive the hybrid vehicle or electric vehicle to move. However, when the rest volume of the electric power stored in the battery is insufficient for driving the hybrid vehicle or electric vehicle to move a certain mileage desired by the user (i.e., the mileage that the user desires to drive the hybrid vehicle or electric vehicle), the user has to charge the battery. However, the user must wait a certain time for charging the battery full, and cannot instantly access sufficient electric power for driving the vehicle. As such, the user often feels inconvenience and disturbed. Further, sometimes, the rest volume of the electric power stored in the battery is higher than a lower power charging threshold which indicates a necessity of charging or replacing the battery but insufficient for driving the desired mileage. For example, when the rest volume of the electric power stored in the battery is capable of driving the vehicle 70 km, while the user desires to drive the vehicle 100 km, the user has to charge the battery for compensating the need of the 30 km. However, it is known that when a battery is charged when the rest volume of electric power stored in the battery is higher than the lower power charging threshold, the lifespan of the battery might be adversely affected, or the battery cannot be fully charged.

As such, it is desired to provide a battery power service management system and a battery power service management method corresponding thereto adapted for providing a battery power service for hybrid vehicles or electric vehicles. The battery power service management system and the battery power service management method corresponding thereto are adapted to provide a corresponding battery service for providing electric power for driving the hybrid vehicle or electric vehicle a desired mileage. In accordance with the present invention, a backup battery having a corresponding electric power volume capable of driving the hybrid vehicle or the electric vehicle to run the desired mileage is provided for replacing the original battery of the hybrid vehicle or the electric vehicle, no matter the electric power volume presently stored in the original battery is higher or lower than the lower power charging threshold. In such a way, the insufficiency of electric power can be instantly solved and the user does not have to wait for charging the original battery. Further, it is also desired to charge the battery for satisfying the demand of driving the vehicle to run the desired mileage.

### SUMMARY OF THE INVENTION

Accordingly, a primary objective of the present invention is to provide a battery power service management system and a battery power service management method corresponding thereto. The present invention is adapted for providing battery power service for a hybrid vehicle and/or an electric vehicle. The present invention is further adapted for instantly providing a backup battery having an electric power volume capable of driving the hybrid vehicle or the electric vehicle to run a predetermined mileage for replacing an original battery of the hybrid vehicle or electric vehicle, when an electric power volume of the original battery is insufficient to drive the hybrid vehicle or electric vehicle to run the predetermined mileage. As such, in accordance with the present invention, the insufficiency of electric power can be instantly solved and the user does not have to wait for charging the original battery.

A further objective of the present invention is to provide a battery power service management system and a battery power service management method. The present invention is adapted for providing battery power service for a hybrid vehicle and/or an electric vehicle. The present invention is further adapted for instantly providing a backup battery having an electric power volume capable of driving the hybrid vehicle or the electric vehicle to run a predetermined mileage for replacing an original battery of the hybrid vehicle or electric vehicle, when an electric power volume of the original battery is insufficient to drive the hybrid vehicle or electric vehicle to run the predetermined mileage, no matter the electric power volume presently stored in the original battery is higher or lower than a lower power charging threshold.

Another objective of the present invention is to provide a battery power service management system and a battery power service management method. The present invention is adapted for providing battery power service for a hybrid vehicle and/or an electric vehicle. The present invention is further adapted for charging a battery of the hybrid vehicle or electric vehicle to achieve an electric power volume capable of driving the hybrid vehicle or the electric vehicle to run a predetermined mileage, when an original electric power volume of the battery is insufficient to drive the hybrid vehicle or electric vehicle to run the predetermined mileage, no matter the original electric power volume of the battery is higher or lower than a lower power charging threshold.

For achieving the foregoing objectives and others, the present invention provides a battery power service management system and a battery power service management method. The battery power service management system at least includes a measuring/determining module, a management module, and a database.

The measuring/determining module is adapted for measuring and determining the electric power volume of the original battery of the hybrid vehicle or electric vehicle, and transmitting an information indicating the measured/determined electric power volume of the original battery of the hybrid vehicle or electric vehicle to the management module.

The management module receives the information of the measured/determined electric power volume of the original battery of the hybrid vehicle or electric vehicle. In accordance with the received information and facilitated with data and information of a plurality of backup batteries previously saved in the database, the management module processes, controls, operates, and manages the backup batteries for instantly providing at least one of the backup batteries to at least one vehicle at a client end for providing an electric power volume adapted for driving the vehicle to run a mileage desired by a user of the vehicle. The backup batteries are adapted for replacing an original battery originally used by the vehicle which electric power volume is insufficient for driving the vehicle to run the mileage desired by the user of the vehicle. The data and information related to the battery replacement operation and/or the present quantity of the backup batteries are then instantly or individually saved in the database or transmitted to a third party by the management module. The management module then estimates a demanded quantity of the backup batteries for satisfying a demand of electric power volume at the client end, so as to determine whether or not to increase or decrease the present quantity of the backup batteries.

The backup batteries can be provided either by the third party or by the battery power service management system.

The database is adapted for saving the data and the information related to the backup batteries, such as data and information related to the battery replacement operation and/or the present quantity of the backup batteries. The data and the information saved in the database are provided for the management module for estimating the demanded quantity of the backup batteries, so as to determine whether or not to increase or decrease the present quantity of the backup batteries.

Further, according to a further embodiment of the present invention, the battery power service management system further includes a charging module for providing a charging service. The charging module is adapted for sending a request to the measuring/determining module for accessing the information of the measured/determined electric power volume of the original battery of the vehicle, and charging the original battery in accordance with the accessed information, so that the original battery is charged to obtain an electric power volume sufficient for driving the vehicle to run the desired mileage. After completing the charging operation, the charging module outputs a message to the management module to inform the management module the completion of the charging operation. Correspondingly, the management module writes a corresponding data recording the charging operation in the database.

According to the battery power service management method, at first, an electric power volume measuring/determining step is executed to measure and determine a present electric power volume of a vehicle (hybrid vehicle or electric vehicle) at a client end is measured and determined, so as to obtain an information of the electric power volume of the original battery of the vehicle.

Then, a battery power service is provided in accordance with a mileage that the vehicle desired to be driven.

According to an aspect of the embodiment, the battery power service is an instant service. Specifically, at first, the measuring/determining module transmits the information of the electric power volume of the original battery of the vehicle to the management module. The electric power volume of the original battery of the vehicle to the management module is lower than a lower power charging threshold which indicates a necessity of charging or replacing the battery, or higher than the lower power charging threshold but insufficient for driving the vehicle to run the desired mileage. The management module receives the information of the measured/determined electric power volume of the original battery of the hybrid vehicle or electric vehicle. In accordance with the received information and facilitated with data and information of a plurality of backup batteries previously saved in the database, the management module processes, controls, operates, and manages the backup batteries for instantly providing at least one of the backup batteries to at least one vehicle at a client end for providing an electric power volume adapted for driving the vehicle to run a mileage desired by a user of the vehicle. The backup batteries are adapted for replacing an original battery originally used by the vehicle which electric power volume is insufficient for driving the vehicle to run the mileage desired by the user of the vehicle.

The data and information related to the battery replacement operation and/or the present quantity of the backup batteries are then instantly or individually saved in the database or transmitted to a third party by the management module. The management module then estimates a demanded quantity of the backup batteries for satisfying a demand of electric power volume at the client end, so as to determine whether or not to increase or decrease the present quantity of the backup batteries.

Further, it should be noted that the battery power service management method is adapted for providing either an instant battery power service or a non-instant battery power service.

Specifically, after the electric power volume measuring/determining step, the non-instant battery power service is provided. At first, the charging module sends a request to the measuring/determining module for accessing the information of the measured/determined electric power volume of the original battery of the vehicle.

Then, the charging module charges the original battery in accordance with the accessed information, so that the original battery is charged to obtain an electric power volume sufficient for driving the vehicle to run the desired mileage.

In summary, in accordance with the battery power service management system and the battery power service management method, when the electric power volume of the original battery is insufficient, an instant battery power service can be provided for instantly providing at least one of a plurality of backup batteries to the vehicle at the client end for use, so as to provide sufficient electric power volume to the vehicle at the client end to allow the vehicle to be driven to run a desired mileage. The backup batteries are adapted for replacing an original battery originally used by the vehicle which electric power volume is insufficient for driving the vehicle to run the mileage desired by the user of the vehicle. Further, alternatively, in accordance with the battery power service management system and battery power service management method, when the electric power volume of the original battery is insufficient, a non-instant battery power service can be provided. The non-instant battery power service is a charging service. Specifically, the original battery is charged to obtain an electric power volume sufficient for driving the vehicle to run the desired mileage in accordance with the information indicating the measured/determined electric power volume of the original battery. The battery power service management system and the battery power service management method are adapted for providing the instant battery power service or the non-instant battery power service in accordance with the practical demand.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a block diagram illustrating a system architecture and the operation of a battery power service management system according to an embodiment of the present invention;

FIG. 2 is a flow chart illustrating a process of performing a battery power service management method with the battery power service management system as shown in FIG. 1;

FIG. 3 is a flow chart illustrating details of a specific step of providing a battery power service corresponding to a mileage that the vehicle is desired to be driven of the process illustrated in FIG. 2;

FIG. 4 is a flow chart illustrating details of another specific step of providing a battery power service corresponding to a mileage that the vehicle is desired to be driven of the process illustrated in FIG. 2;

FIG. 5 is a schematic diagram illustrating a battery power service management system according to an embodiment of the present invention;

FIG. 6 is a flow chart illustrating a process of performing a battery power service management method with the battery power service management system as shown in FIG. 5;

FIG. 7 is a schematic diagram illustrating a battery power service management system according to another embodiment of the present invention; and

FIG. 8 is a flow chart illustrating a process of performing a battery power service management method with the battery power service management system as shown in FIG. 7;

FIG. 9 is a schematic diagram illustrating a battery power service management system according to a further embodiment of the present invention; and

FIG. 10 is a flow chart illustrating a process of performing a battery power service management method with the battery power service management system as shown in FIG. 9.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

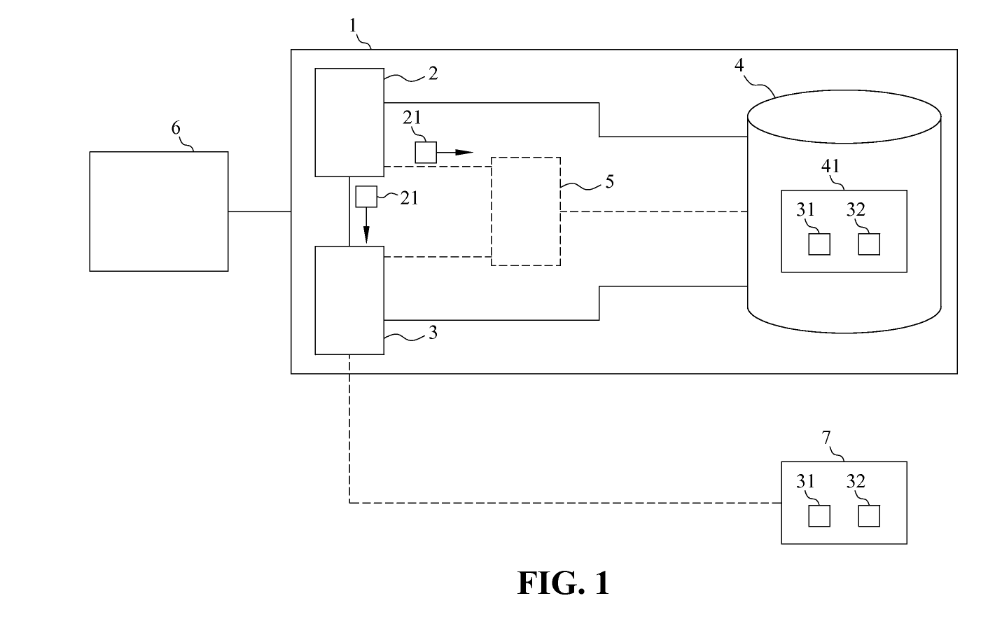

FIG. 1 is a block diagram illustrating a system architecture and the operation of a battery power service management system according to an embodiment of the present invention. Referring to FIG. 1, a battery power service management system 1 is shown. The battery power service management system 1 includes at least a measuring/determining module 2, a management module 3, and a database 4.

The measuring/determining module 2 is adapted for measuring and determining the electric power volume of the original battery (not shown in the drawings) presently used by the hybrid vehicle or electric vehicle (not shown in the drawings), and transmitting an information 21 indicating the measured/determined electric power volume of the original battery of the hybrid vehicle or electric vehicle to the management module 3.

The management module 3 receives the information 21 of the measured/determined electric power volume of the original battery of the hybrid vehicle or electric vehicle. In accordance with the received information 21, the management module 3 determines whether the electric power volume of the original battery is lower than a lower power charging threshold which indicates a necessity of charging or replacing the battery, and/or whether the electric power volume of the original battery is higher than the lower power charging threshold but insufficient for driving the vehicle to run the desired mileage. Facilitated with data and information 41 of a plurality of backup batteries previously saved in the database 4, the management module 3 processes, controls, operates, and manages the backup batteries (not shown in the drawings) in accordance with the information 21 for instantly providing at least one of the backup batteries to at least one vehicle at a client end 6 for providing an electric power volume adapted for driving the vehicle to run the mileage desired by a user of the vehicle. The backup batteries are adapted for replacing the original battery originally used by the vehicle which electric power volume is insufficient for driving the vehicle to run the mileage desired by the user of the vehicle. Data and information 31 related to the battery replacement operation and/or data and information 32 related to the present quantity of the backup batteries are then instantly or individually saved in the database 4 or transmitted to a third party 7 by the management module 3. The management module 3 then estimates a demanded quantity of the backup batteries for satisfying a demand of electric power volume at the client end 6, so as to determine whether or not to increase or decrease the present quantity of the backup batteries. According to the present embodiment, the backup batteries are provided by the third party 7 or the battery power service management system 1.

The database 4 is adapted for saving the data and the information 41 related to the backup batteries. The data and information 41 include data and information 31 related to the battery replacement operation and/or data and information 32 related to the present quantity of the backup batteries. The data and information 41 saved in the database 4 are provided for the management module 3 for estimating the demanded quantity of the backup batteries, so as to determine whether or not to increase or decrease the present quantity of the backup batteries.

Further, according to a further embodiment of the present invention, the battery power service management system 1 of the present invention further includes a charging module 5 for providing a charging service. The charging module 5 is adapted for sending a request to the measuring/determining module 2 for accessing the information 21 of the measured/determined electric power volume of the original battery of the vehicle, and charging the original battery in accordance with the accessed information 21, so that the original battery is charged to obtain an electric power volume sufficient for driving the vehicle to run the desired mileage. After completing the charging operation, the charging module 5 outputs a message (not shown in the drawings) to the management module 3 to inform the management module 3 the completion of the charging operation. Correspondingly, the management module 3 writes a corresponding data recording the charging operation in the database 4.

The battery power service management system 1 is adapted for providing an instant battery power service and/or a non-instant battery power service in accordance with the practical demand.

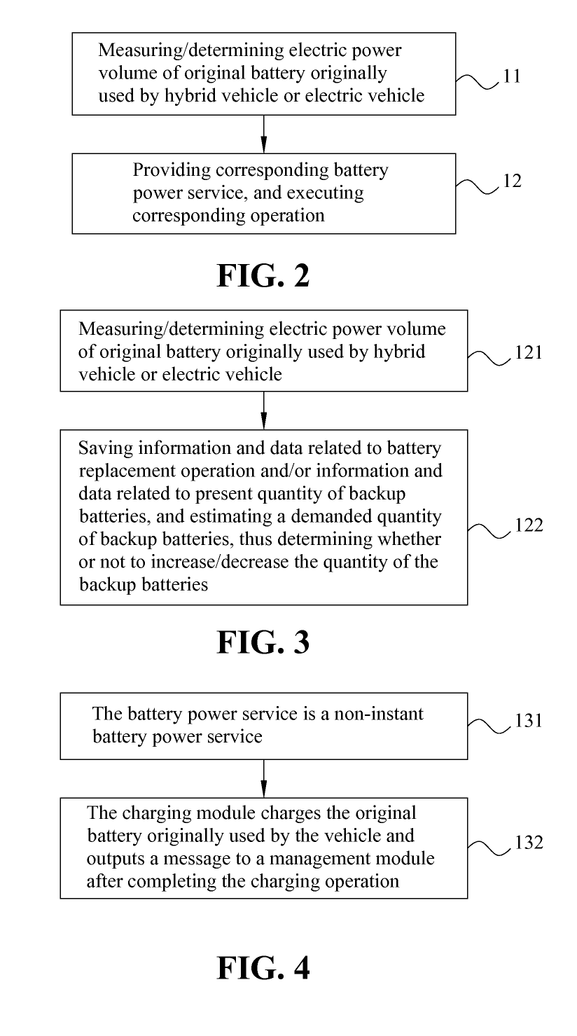

FIG. 2 is a flow chart illustrating a process of performing a battery power service management method with the battery power service management system as shown in FIG. 1. Referring to FIG. 2, at first, in step 11, the electric power volume of the original battery used by the vehicle is measured and determined. Specifically, the measuring/determining module 2 measures and determines the electric power volume of the original battery (not shown in the drawings) presently used by the hybrid vehicle or electric vehicle (not shown in the drawings) so as to obtain an information 21 indicating the measured/determined electric power volume of the original battery of the hybrid vehicle or electric vehicle. Then, the flow enters step 12.

In step 12, a battery power service corresponding to a mileage that the vehicle is desired to be driven is provided according to the information 21, and the battery power service is executed.

FIG. 3 is a flow chart illustrating details of a specific step of providing a battery power service corresponding to a mileage that the vehicle is desired to be driven of the process illustrated in FIG. 2. Specifically, in this embodiment, the battery power service is an instant battery power service. As shown in FIG. 3, at first in step 121, when the provided battery power service is an instant battery power service, the measuring/determining module 2 transmits the information 21 indicating the measured/determined electric power volume of the original battery of the hybrid vehicle or electric vehicle to the management module 3. The electric power volume of the original battery is lower than a lower power charging threshold which indicates a necessity of charging or replacing the battery, and/or the electric power volume of the original battery is higher than the lower power charging threshold but insufficient for driving the vehicle to run the desired mileage. Facilitated with data and information 41 of a plurality of backup batteries previously saved in the database 4, the management module 3 processes, controls, operates, and manages the backup batteries (not shown in the drawings) in accordance with the information 21 for instantly providing at least one of the backup batteries to at least one vehicle at a client end 6 for providing an electric power volume adapted for driving the vehicle to run the mileage desired by a user of the vehicle. The backup batteries are adapted for replacing the original battery originally used by the vehicle which electric power volume is insufficient for driving the vehicle to run the mileage desired by the user of the vehicle. Then, the flow enters step 122.

In step 122, data and information 31 related to the battery replacement operation and/or data and information 32 related to the present quantity of the backup batteries are then instantly or individually saved in the database 4 or transmitted to a third party 7 by the management module 3. The management module 3 estimates a demanded quantity of the backup batteries for satisfying a demand of electric power volume at the client end 6, so as to determine whether or not to increase or decrease the present quantity of the backup batteries. According to the present embodiment, the backup batteries are provided by the third party 7 or the battery power service management system 1.

FIG. 4 is a flow chart illustrating details of another specific step of providing a battery power service corresponding to a mileage that the vehicle is desired to be driven of the process illustrated in FIG. 2. Specifically, in this embodiment, the battery power service is a non-instant battery power service. In this embodiment, the non-instant battery power service means that the battery power service is a charging service. As shown in FIG. 4, at first in step 131, the provided battery power service is a non-instant battery power service, and the charging module 5 sends a request to the measuring/determining module 2 for accessing the information 21 of the measured/determined electric power volume of the original battery of the vehicle. Then, the flow enters step 132.

In step 132, the charging module 5 charges the original battery in accordance with the accessed information 21, so that the original battery is charged to obtain an electric power volume sufficient for driving the vehicle to run the desired mileage. After completing the charging operation, the charging module 5 outputs a message (not shown in the drawings) to the management module 3 to inform the management module 3 the completion of the charging operation. Correspondingly, the management module 3 writes a corresponding data recording the charging operation in the database 4.

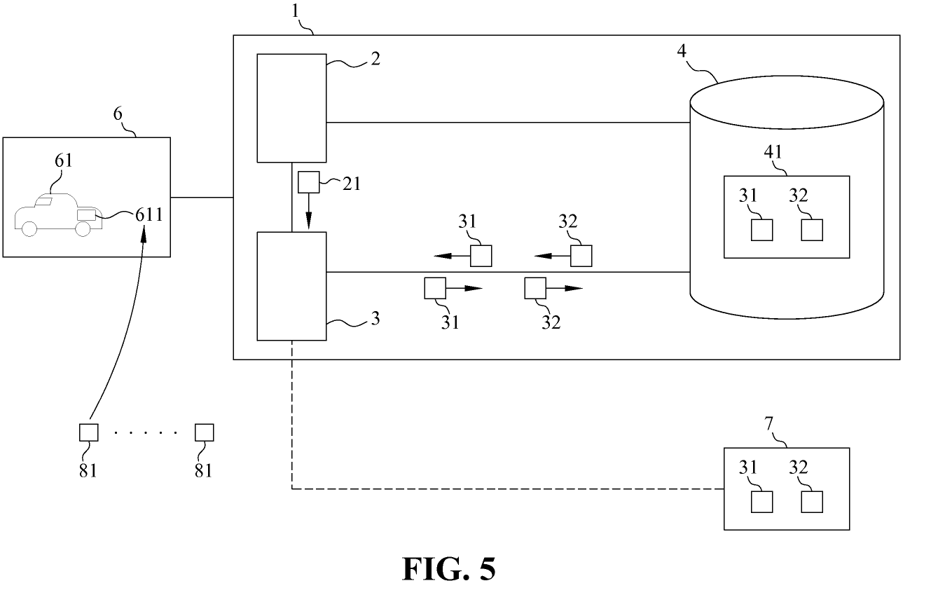

FIG. 5 is a schematic diagram illustrating a battery power service management system according to an embodiment of the present invention. Referring to FIG. 5, the battery power service management system 1 includes at least a measuring/determining module 2, a management module 3, and a database 4.

The measuring/determining module 2 is adapted for measuring and determining the electric power volume of the original battery 611 presently used by the hybrid vehicle or electric vehicle 61 at the client end 6, and transmitting an information 21 indicating the measured/determined electric power volume of the original battery 611 of the hybrid vehicle or electric vehicle 61 to the management module 3.

The management module 3 receives the information 21 of the measured/determined electric power volume of the original battery 611 of the hybrid vehicle or electric vehicle 61. In accordance with the received information 21, the management module 3 learns that the electric power volume of the original battery 611 is for example 10% of a full volume of the original battery 611, and the electric power volume of the original battery 611 (i.e., 10% of the full volume of the original battery 611) is insufficient for driving the vehicle to run the desired mileage, and lower than a lower power charging threshold (e.g., 20% of the full volume of the original battery 611) which indicates a necessity of charging or replacing the original battery. As such, the management module 3 determines to provide a battery power service. Facilitated with data and information 41 of a plurality of backup batteries previously saved in the database 4, the management module 3 processes, controls, operates, and manages the backup batteries 81 in accordance with the information 21 for instantly providing at least one of the backup batteries 81 to at least one vehicle 61 at the client end 6 for providing an electric power volume adapted for driving the vehicle to run the mileage desired by a user of the vehicle. The backup battery 81 is provided for replacing the original battery 611 originally used by the vehicle 61 which electric power volume is insufficient for driving the vehicle 61 to run the mileage desired by the user of the vehicle 61. In other words, after the battery replacement operation, the backup battery 81 is installed in the vehicle 61, and the original battery 611 is taken away from the vehicle 61. Then, the data and information 31 related to the battery replacement operation and/or data and information 32 related to the present quantity of the backup batteries 81 are then instantly or individually saved in the database 4 or transmitted to a third party 7 by the management module 3. In this case, since one of the backup batteries 81 is used for replacing the original battery 611, comparing with original situation, the quantity of the backup batteries 81 decreases 1, and there is increased a battery having insufficient electric power volume (original battery 611) which can be charged to serve as another backup battery 81. The management module 3 then records the replacement of the backup battery 81 and the original battery 611 in the data and information 31 related to the battery replacement operation and/or the data and information 32 related to the present quantity of the backup batteries 81. The management module 3 then estimates a demanded quantity of the backup batteries 81 for satisfying a demand of electric power volume at the client end 6, so as to determine whether or not to increase or decrease the present quantity of the backup batteries 81. According to the present embodiment, the backup batteries are provided by the third party 7 or the battery power service management system 1.

The database 4 is adapted for saving the data and the information 41 related to the backup batteries 81 before and/or after the battery replacement operation. The data and information 41 include the data and information 31 related to the battery replacement operation and/or the data and information 32 related to the present quantity of the backup batteries 81. The data and information 41 saved in the database 4 are provided for the management module 3 for estimating the demanded quantity of the backup batteries, so as to determine whether or not to increase or decrease the present quantity of the backup batteries 81.

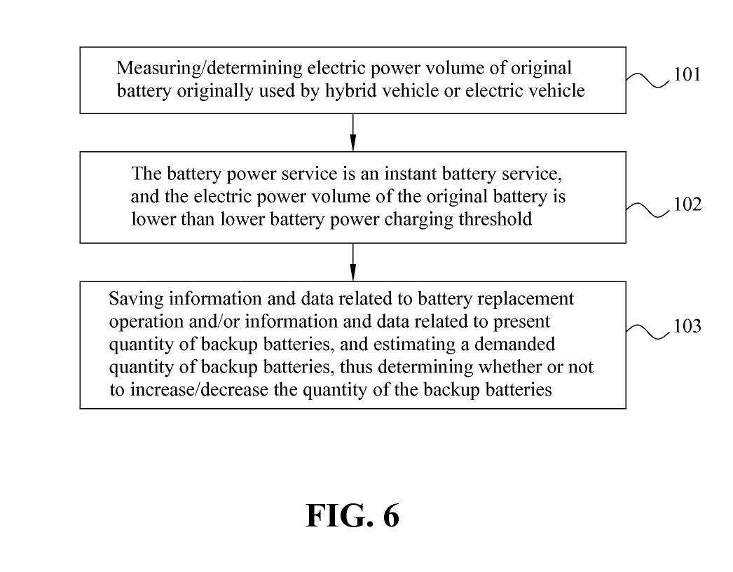

FIG. 6 is a flow chart illustrating a process of performing a battery power service management method with the battery power service management system as shown in FIG. 5. Referring to FIG. 6, at first in step 101, the measuring/determining module 2 measures and determines the electric power volume of the original battery 611 presently used by the hybrid vehicle or electric vehicle 61 at the client end 6, and obtains an information 21 indicating the measured/determined electric power volume of the original battery 611 of the hybrid vehicle or electric vehicle 61. Then, the flow enters step 102.

In step 102, a battery power service of providing the electric power volume sufficient for driving the vehicle 61 the desired mileage is provided, and the battery power service is executed. Specifically, the provided battery power service is an instant battery power service. The measuring/determining module 2 transmits the information 21 to the management module 3. The management module 3 receives the information 21 of the measured/determined electric power volume of the original battery 611 of the hybrid vehicle or electric vehicle 61. In accordance with the received information 21, the management module 3 learns that the electric power volume of the original battery 611 is for example 10% of a full volume of the original battery 611. The electric power volume of the original battery 611 (i.e., 10% of the full volume of the original battery 611) is lower than a lower power charging threshold (e.g., 20% of the full volume of the original battery 611) which indicates a necessity of charging or replacing the original battery. As such, the management module 3 determines to provide a battery power service. Facilitated with data and information 41 of a plurality of backup batteries previously saved in the database 4, the management module 3 processes, controls, operates, and manages the backup batteries 81 in accordance with the information 21 for instantly providing at least one of the backup batteries 81 to at least one vehicle 61 at the client end 6 for providing an electric power volume adapted for driving the vehicle 61 to run the mileage desired by a user of the vehicle 61. The backup battery 81 is provided for replacing the original battery 611 originally used by the vehicle 61 which electric power volume is insufficient for driving the vehicle 61 to run the mileage desired by the user of the vehicle 61. In other words, after the battery replacement operation, the backup battery 81 is installed in the vehicle 61, and the original battery 611 is taken away from the vehicle 61. Then, the flow enters step 103.

In step 103, the data and information 31 related to the battery replacement operation and/or data and information 32 related to the present quantity of the backup batteries 81 are then instantly or individually saved in the database 4 or transmitted to a third party 7 by the management module 3. In this case, since one of the backup batteries 81 is used for replacing the original battery 611, comparing with original situation, the quantity of the backup batteries 81 decreases 1, and there is increased a battery having insufficient electric power volume (original battery 611) which can be charged to serve as another backup battery 81. The management module 3 then records the replacement of the backup battery 81 and the original battery 611 in the data and information 31 related to the battery replacement operation and/or the data and information 32 related to the present quantity of the backup batteries 81. The management module 3 then estimates a demanded quantity of the backup batteries 81 for satisfying a demand of electric power volume at the client end 6, so as to determine whether or not to increase or decrease the present quantity of the backup batteries 81. According to the present embodiment, the backup batteries are provided by the third party 7 or the battery power service management system 1.

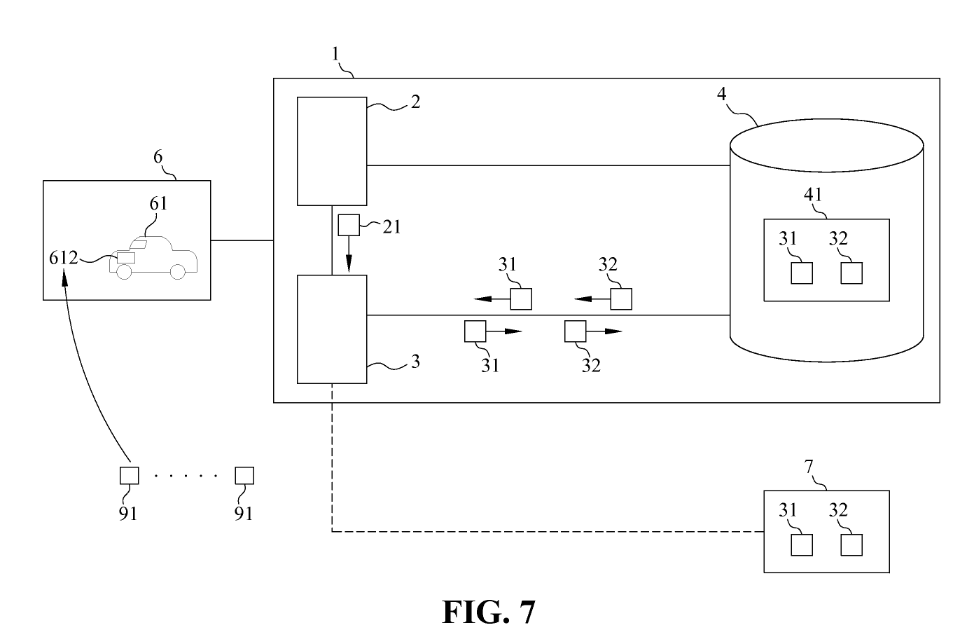

FIG. 7 is a schematic diagram illustrating a battery power service management system according to another embodiment of the present invention. Referring to FIG. 7, the battery power service management system 1 includes at least a measuring/determining module 2, a management module 3, and a database 4.

The measuring/determining module 2 is adapted for measuring and determining the electric power volume of the original battery 612 presently used by the hybrid vehicle or electric vehicle 61 at the client end 6, and transmitting an information 21 indicating the measured/determined electric power volume of the original battery 612 of the hybrid vehicle or electric vehicle 61 to the management module 3.

The management module 3 receives the information 21 of the measured/determined electric power volume of the original battery 612 of the hybrid vehicle or electric vehicle 61. In accordance with the received information 21, the management module 3 learns that the electric power volume of the original battery 612 is for example 30% of a full volume of the original battery 612, and the electric power volume of the original battery 612 (i.e., 30% of the full volume of the original battery 612) is capable of driving the vehicle 61 to run 30 km only, and is insufficient for driving the vehicle 61 to run the desired mileage (e.g., 50 km), and is higher than a lower power charging threshold (e.g., 20% of the full volume of the original battery 612) which indicates a necessity of charging or replacing the original battery. In other words, the original battery 612 is incapable of driving the vehicle 61 to run the desired mileage, i.e., 50 km. Facilitated with data and information 41 of a plurality of backup batteries 91 previously saved in the database 4, the management module 3 processes, controls, operates, and manages the backup batteries 91 in accordance with the information 21 for instantly providing at least one of the backup batteries 81 to at least one vehicle 61 at the client end 6 for providing an electric power volume adapted for driving the vehicle 61 to run the mileage (i.e., 50 km) desired by a user of the vehicle 61. The backup battery 91 is provided for replacing the original battery 612 originally used by the vehicle 61 which electric power volume is capable of driving the vehicle 61 to run 30 km only. In other words, after the battery replacement operation, the backup battery 91 is installed in the vehicle 61, and the original battery 612 is taken away from the vehicle 61. Then, the data and information 31 related to the battery replacement operation and/or data and information 32 related to the present quantity of the backup batteries 81 are then instantly or individually saved in the database 4 or transmitted to a third party 7 by the management module 3. In this case, since one of the backup batteries 91 is used for replacing the original battery 612, comparing with original situation, the quantity of the backup batteries 91 decreases 1, and there is increased a battery having electric power volume capable of driving the vehicle 61 to run 30 km only (original battery 612). The management module 3 then records the replacement of the backup battery 91 and the original battery 612 in the data and information 31 related to the battery replacement operation and/or the data and information 32 related to the present quantity of the backup batteries 91. The management module 3 then estimates a demanded quantity of the backup batteries 91 for satisfying a demand of electric power volume at the client end 6, so as to determine whether or not to increase or decrease the present quantity of the backup batteries 81. According to the present embodiment, the backup batteries are provided by the third party 7 or the battery power service management system 1.

The database 4 is adapted for saving the data and the information 41 related to the backup batteries 91 before and/or after the battery replacement operation. The data and information 41 include the data and information 31 related to the battery replacement operation and/or the data and information 32 related to the present quantity of the backup batteries 91. The data and information 41 saved in the database 4 are provided for the management module 3 for estimating the demanded quantity of the backup batteries, so as to determine whether or not to increase or decrease the present quantity of the backup batteries 91.

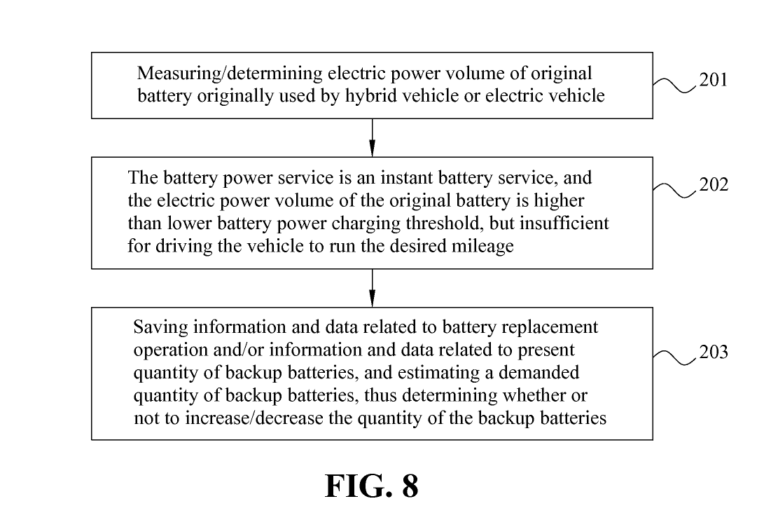

FIG. 8 is a flow chart illustrating a process of performing a battery power service management method with the battery power service management system as shown in FIG. 7. Referring to FIG. 8, at first in step 201, the measuring/determining module 2 measures and determines the electric power volume of the original battery 612 presently used by the hybrid vehicle or electric vehicle 61 at the client end 6, and obtains an information 21 indicating the measured/determined electric power volume of the original battery 612 of the hybrid vehicle or electric vehicle 61. Then, the flow enters step 202.

In step 202, a battery power service of providing the electric power volume sufficient for driving the vehicle 61 the desired mileage is provided, and the battery power service is executed. Specifically, the provided battery power service is an instant battery power service. The measuring/determining module 2 transmits the information 21 to the management module 3. The management module 3 receives the information 21 of the measured/determined electric power volume of the original battery 612 of the hybrid vehicle or electric vehicle 61. In accordance with the received information 21, the management module 3 learns that the electric power volume of the original battery 612 is for example 30% of a full volume of the original battery 612, and the electric power volume of the original battery 612 (i.e., 30% of the full volume of the original battery 612) is capable of driving the vehicle 61 to run 30 km only, and is insufficient for driving the vehicle 61 to run the desired mileage (e.g., 50 km), and is higher than a lower power charging threshold (e.g., 20% of the full volume of the original battery 612) which indicates a necessity of charging or replacing the original battery. As such, the management module 3 determines to provide a battery power service. Facilitated with data and information 41 of a plurality of backup batteries previously saved in the database 4, the management module 3 processes, controls, operates, and manages the backup batteries 81 in accordance with the information 21 for instantly providing at least one of the backup batteries 91 to at least one vehicle 61 at the client end 6 for providing an electric power volume adapted for driving the vehicle 61 to run the mileage (i.e., 50 km hereby) desired by the user of the vehicle 61. The backup battery 91 is provided for replacing the original battery 612 originally used by the vehicle 61 which electric power volume is insufficient for driving the vehicle 61 to run the mileage desired by the user of the vehicle 61. In other words, after the battery replacement operation, the backup battery 91 is installed in the vehicle 61, and the original battery 612 is taken away from the vehicle 61. Then, the flow enters step 203.

In step 203, the data and information 31 related to the battery replacement operation and/or data and information 32 related to the present quantity of the backup batteries 81 are then instantly or individually saved in the database 4 or transmitted to a third party 7 by the management module 3. In this case, since one of the backup batteries 91 is used for replacing the original battery 612, comparing with original situation, the quantity of the backup batteries 91 decreases 1, and there is increased a battery 612 capable of driving the vehicle 61 30 km only. The management module 3 then records the replacement of the backup battery 91 and the original battery 612 in the data and information 31 related to the battery replacement operation and/or the data and information 32 related to the present quantity of the backup batteries 91. The management module 3 then estimates a demanded quantity of the backup batteries 91 for satisfying a demand of electric power volume at the client end 6, so as to determine whether or not to increase or decrease the present quantity of the backup batteries 91. According to the present embodiment, the backup batteries are provided by the third party 7 or the battery power service management system 1.

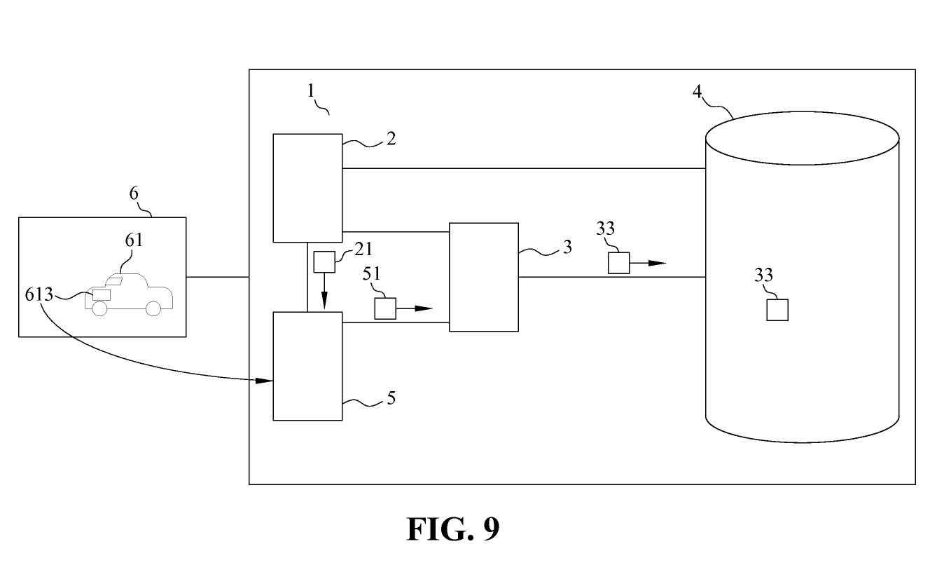

FIG. 9 is a schematic diagram illustrating a battery power service management system according to a further embodiment of the present invention. Referring to FIG. 9, the battery power service management system 1 includes at least a measuring/determining module 2, a management module 3, a database 4, and a charging module 5.

The charging module 5 is adapted for sending a request 51 to the measuring/determining module 2 for accessing the information 21 of the measured/determined electric power volume of an original battery 613 of the vehicle 61. In accordance with the received information 21, the charging module 5 learns that the electric power volume of the original battery 613 is for example 15% of a full volume of the original battery 613, and the electric power volume of the original battery 613 (i.e., 15% of the full volume of the original battery 613) is insufficient for driving the vehicle to run the desired mileage, and lower than a lower power charging threshold (e.g., 30% of the full volume of the original battery 613) which indicates a necessity of charging or replacing the original battery. The charging module 5 then charges the original battery 613 in accordance with the accessed information 21, so that the original battery 613 is charged to obtain an electric power volume sufficient for driving the vehicle 61 to run the desired mileage. After completing the charging operation, the charging module 5 outputs a message 51 to the management module 3 to inform the management module 3 the completion of the charging operation. Correspondingly, the management module 3 writes a corresponding data recording the charging operation in the database 4 and times of complete charging operations.

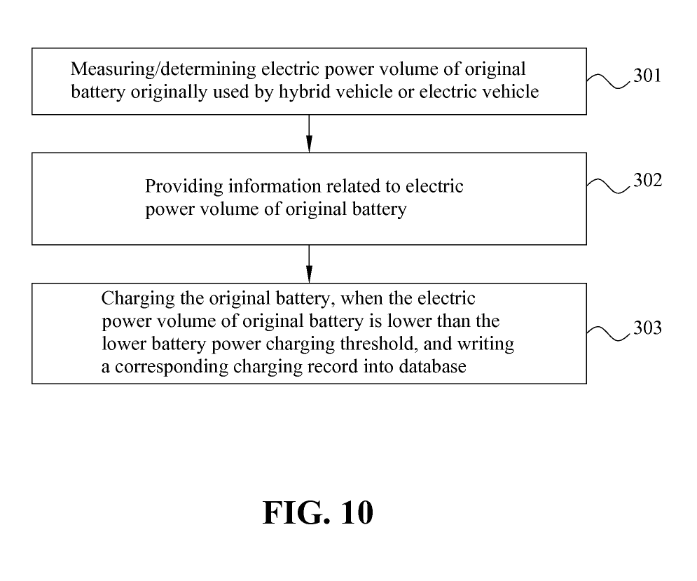

FIG. 10 is a flow chart illustrating a process of performing a battery power service management method with the battery power service management system as shown in FIG. 9. Referring to FIG. 10, at first in step 301, the measuring/determining module 2 measures and determines the electric power volume of the original battery 613 presently used by the hybrid vehicle or electric vehicle 61 at the client end 6, and obtains an information 21 indicating the measured/determined electric power volume of the original battery 613 of the hybrid vehicle or electric vehicle 61. Then, the flow enters step 302.

In step 302, a battery power service of providing the electric power volume sufficient for driving the vehicle 61 the desired mileage is provided, and the battery power service is executed. Specifically, the provided battery power service is a non-instant battery power service, (i.e., a charging service), in which the charging module 5 sends a request to the measuring/determining module 2 for accessing the information 21 of the measured/determined electric power volume of the original battery 613 of the vehicle 61. Then, the flow enters step 303.

In step 303, in accordance with the information 21, the charging module 5 learns that the electric power volume of the original battery 613 is for example 15% of a full volume of the original battery 613, and the electric power volume of the original battery 613 (i.e., 15% of the full volume of the original battery 613) is insufficient for driving the vehicle to run the desired mileage, and lower than a lower power charging threshold (e.g., 30% of the full volume of the original battery 613) which indicates a necessity of charging or replacing the original battery. The charging module 5 then charges the original battery 613 in accordance with the accessed information 21, so that the original battery 613 is charged to obtain an electric power volume sufficient for driving the vehicle 61 to run the desired mileage. After completing the charging operation, the charging module 5 outputs a message 51 to the management module 3 to inform the management module 3 the completion of the charging operation. Correspondingly, the management module 3 writes a corresponding data recording the charging operation in the database 4 and times of complete charging operations.

In accordance with the all above-mentioned embodiments, the present invention provides a battery power service management system and a battery power service management method corresponding thereto. The present invention is adapted for providing an instant battery power service in which a backup battery having an electric power volume sufficient for driving the vehicle to run a desired mileage is provided for replacing an original battery originally used by the vehicle which electric power volume is insufficient for driving the vehicle to run the desired mileage, and/or providing a non-instant battery power service in which the original battery is charged from an electric power volume insufficient for driving the vehicle to run the desired mileage to an electric power volume sufficient for driving the vehicle to run the desired mileage, in accordance with the desired mileage that the user of the vehicle desires to drive the vehicle to run. The battery power service management system and the battery power service management method corresponding thereto of the present invention are capable of providing a corresponding battery power service in accordance with the desired mileage that the hybrid vehicle or the electric vehicle is desired to run. In general, the present invention has the following advantages:

1. The present invention is adapted for instantly providing a backup battery having an electric power volume capable of driving the hybrid vehicle or the electric vehicle to run a predetermined mileage for replacing an original battery of the hybrid vehicle or electric vehicle, when an electric power volume of the original battery is insufficient to drive the hybrid vehicle or electric vehicle to run the predetermined mileage. As such, in accordance with the present invention, the insufficiency of electric power can be instantly solved and the user does not have to wait for charging the original battery.

2. The present invention is adapted for providing battery power service for a hybrid vehicle and/or an electric vehicle. The present invention is further adapted for instantly providing a backup battery having an electric power volume capable of driving the hybrid vehicle or the electric vehicle to run a predetermined mileage for replacing an original battery of the hybrid vehicle or electric vehicle, when an electric power volume of the original battery is insufficient to drive the hybrid vehicle or electric vehicle to run the predetermined mileage, no matter the electric power volume presently stored in the original battery is higher or lower than a lower power charging threshold.

3. The present invention is further adapted for charging a battery of the hybrid vehicle or electric vehicle to achieve an electric power volume capable of driving the hybrid vehicle or the electric vehicle to run a predetermined mileage, when an original electric power volume of the battery is insufficient to drive the hybrid vehicle or electric vehicle to run the predetermined mileage, no matter the original electric power volume of the battery is higher or lower than a lower power charging threshold.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A battery power service management method, applicable for a vehicle-used battery charging environment, comprising:
measuring and determining an electric power volume of an original battery used by a hybrid vehicle or electric vehicle, and obtaining an information related to the measured and determined electric power volume of the original battery; and
providing a battery power service in accordance with the information for allowing the hybrid vehicle or electric vehicle to obtain an electric power volume sufficient for driving the hybrid vehicle to run a mileage desired by a user of the hybrid vehicle or electric vehicle, and executing an operation of the corresponding battery power service.

2. The battery power service management method as claimed in claim 1, wherein the step of providing the battery power service is an instant battery power service comprising the following steps:
processing, controlling, operating, and managing a plurality of backup batteries in accordance with the information and facilitated with data and information of the backup batteries, and instantly providing at least one of the backup batteries to the hybrid vehicle or electric vehicle, wherein the provided backup battery is provided for replacing the original battery of the hybrid vehicle or electric vehicle which electric power volume is insufficient for driving the hybrid vehicle or electric vehicle to run the desired mileage; and
estimating a demanded quantity of the backup batteries, and determining whether or not to increase or decrease the quantity of the backup batteries.

3. The battery power service management method as claimed in claim 1, wherein the step of providing the battery power service is a non-instant battery power service comprising the following steps:
receiving the information related to the measured and determined electric power volume of the original battery;
charging the original battery in accordance with the received information, so that the charged original battery obtains an electric power volume capable of driving the hybrid vehicle or electric vehicle to run the desired mileage; and
recording times of completed charging operation(s).

4. The battery power service management method as claimed in claim 2, wherein it can be learnt from the information related to the measured and determined electric power volume of the original battery that the electric power volume of the original battery is lower than a lower power charging threshold.

5. The battery power service management method as claimed in claim 2, wherein it can be learnt from the information related to the measured and determined electric power volume of the original battery that the electric power volume of the original battery is higher than a lower power charging threshold, but insufficient for driving the hybrid vehicle or electric vehicle to run the desired mileage.

6. The battery power service management method as claimed in claim 3, wherein it can be learnt from the information related to the measured and determined electric power volume of the original battery that the electric power volume of the original battery is lower than a lower power charging threshold.

7. A battery power service management method, applicable for a vehicle-used battery charging environment, comprising:
using a measuring/determining module to measure and determine an electric power volume of an original battery used by a hybrid vehicle or electric vehicle at a client end, and obtain an information related to the measured and determined electric power volume of the original battery; and
providing a battery power service in accordance with the information for allowing the hybrid vehicle or electric vehicle to obtain an electric power volume sufficient for driving the hybrid vehicle to run a mileage desired by a user of the hybrid vehicle or electric vehicle, and executing an operation of the corresponding battery power service.

8. The battery power service management method as claimed in claim 7, wherein the step of providing the battery power service is an instant battery power service comprising the following steps:
the measuring/determining module transmitting the information related to the measured and determined electric power volume of the original battery to a management module;
the management module receiving the information, and processing, controlling, operating, and managing a plurality of backup batteries in accordance with the information and facilitated with data and information of the backup batteries, and instantly providing at least one of the backup batteries to the hybrid vehicle or electric vehicle, wherein the provided backup battery is provided for replacing the original battery of the hybrid vehicle or electric vehicle which electric power volume is insufficient for driving the hybrid vehicle or electric vehicle to run the desired mileage;
the management module instantly or individually saving data and information related to the battery replacement operation and/or information related to a present quantity of the backup batteries into a database or transmitting the data and information related to the battery replacement operation and/or information related to the present quantity of the backup batteries to a third party; and
the management module estimating a demanded quantity of the backup batteries, and determining whether or not to increase or decrease the quantity of the backup batteries.

9. The battery power service management method as claimed in claim 7, wherein the step of providing the battery power service is a non-instant battery power service comprising the following steps:
the charging module sending a request to the measuring/determining module for accessing the information related to the measured and determined electric power volume of the original battery;
the charging module charging the original battery in accordance with the accessed information, so that the charged original battery obtains an electric power volume capable of driving the hybrid vehicle or electric vehicle to run the desired mileage; and
recording times of completed charging operation(s).

10. The battery power service management method as claimed in claim 8, wherein it can be learnt from the information related to the measured and determined electric power volume of the original battery that the electric power volume of the original battery is lower than a lower power charging threshold.

11. The battery power service management method as claimed in claim 8, wherein it can be learnt from the information related to the measured and determined electric power volume of the original battery that the electric power volume of the original battery is higher than a lower power charging threshold, but insufficient for driving the hybrid vehicle or electric vehicle to run the desired mileage.

12. The battery power service management method as claimed in claim 9, wherein it can be learnt from the information related to the measured and determined electric power volume of the original battery that the electric power volume of the original battery is lower than a lower power charging threshold.

13. A battery power service management system, applicable for a vehicle-used battery charging environment, comprising:
a measuring/determining module, adapted for measuring and determining an electric power volume of an original battery presently used by a hybrid vehicle or electric vehicle, to obtain an information indicating the measured/determined electric power volume of the original battery of the hybrid vehicle or electric vehicle;
a management module, receiving the information of the measured/determined electric power volume of the original battery of the hybrid vehicle or electric vehicle, wherein the management module processes, controls, operates, and manages a plurality of backup batteries in accordance with the received information and facilitated with data and information related to the backup batteries, for instantly providing at least one of the backup batteries to the hybrid vehicle or electric vehicle at a client end for providing an electric power volume adapted for driving the vehicle to run a mileage desired by a user of the hybrid vehicle or electric vehicle, wherein the backup batteries are adapted for replacing an original battery originally used by the hybrid vehicle or electric vehicle which electric power volume is insufficient for driving the vehicle to run the mileage desired by the user of the vehicle; and
a database, adapted for saving the data and the information related to the backup batteries, wherein the data and the information related to the backup batteries saved in the database are provided for the management module for estimating a demanded quantity of the backup batteries, so as to determine whether or not to increase or decrease a present quantity of the backup batteries.

14. The battery power service management system as claimed in claim 13, wherein the management module instantly or individually saves data and information related to the battery replacement operation and/or data and information related to the present quantity of the backup batteries into the database or transmits the data and information related to the battery replacement operation and/or the data and information related to the present quantity of the backup batteries to a third party, wherein the information and data related to the backup batteries saved in the database comprise the data and information related to the battery replacement operation and/or data and information related to the present quantity of the backup batteries.

15. The battery power service management system as claimed in claim 13, further comprising a charging module adapted for sending a request to the measuring/determining module for accessing the information related to the measured and determined electric power volume of the original battery, and charging the original battery in accordance with the accessed information, so that the charged original battery obtains an electric power volume capable of driving the hybrid vehicle or electric vehicle to run the desired mileage.

16. The battery power service management system as claimed in claim 15, wherein after completing the charging operation, the charging module outputs a message to the management module to inform the management module the completion of the charging operation, and the management module records the charging operation in the database for recording times of completed charging operation(s).

17. The battery power service management system as claimed in claim 13, wherein the management learns from the information related to the measured and determined electric power volume of the original battery that the electric power volume of the original battery is lower than a lower power charging threshold.

18. The battery power service management system as claimed in claim 13, wherein the management learns from the information related to the measured and determined electric power volume of the original battery that the electric power volume of the original battery is higher than a lower power charging threshold, but insufficient for driving the hybrid vehicle or electric vehicle to run the desired mileage.

19. The battery power service management system as claimed in claim 15, wherein the management learns from the information related to the measured and determined electric power volume of the original battery that the electric power volume of the original battery is lower than a lower power charging threshold.
